(19) United States
(12) Patent Application Publication
(10) Pub. No.: US 2006/0152897 A1
(43) Pub. Date: Jul. 13, 2006

(54) Screen display method of information processing device, information processing device and its storage medium

(75) Inventor: Ryoji Hirayama, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/372,371

(22) Filed: Mar. 10, 2006

Related U.S. Application Data
(63) Continuation of application No. PCT/JP03/11685, filed on Sep. 12, 2003.

(51) Int. Cl. G06F 1/16

(52) U.S. Cl. 361/683; 361/681; 361/680

(57) ABSTRACT

An information processing device accommodates a first enclosure in a second enclosure having a display to hidden a portion of a display screen by the first enclosure. When the first enclosure is accommodated in a display device, an application image is displayed on an exposed screen by modifying screen size information retained in an operating system (OS) of an information processor. A screen display on the exposed screen can be performed without an application for dedicated use. Since modification of the screen size information is executed, a switchover of the screen display to the exposed screen can be performed at high speed, and also with simple processing.

### CROSS-REFERENCE TO RELATED APPLICATIONS

This application is a continuation of international application PCT/JP2003/011685, filed on Sep. 12, 2003.

### BACKGROUND OF THE INVENTION

1. Field of the Invention

The present invention relates to a screen display method of a notebook and desktop information processing devices having structures of accommodating a keyboard, etc. by erecting the keyboard, etc. against a display unit, and the information processing-device and a storage medium therefor, and more particularly, a screen display method of an information processing device, and the information processing device and a storage medium therefor, for controlling a screen display on a display unit when the keyboard is accommodated by erecting the keyboard against a display unit.

2. Description of the Related Art

In recent years, personal computers for individual use, which are structured of a variety of types, including notebook type, desktop type and portable type, are widely used. In such personal computers, there are required an Internet function and an AV (audio visual) function using DVD and TV, in addition to a data processing function. For this reason, a variety of personal computers are provided in the optimal forms depending on users and user environments.

For example, as a personal computer mainly used on a desk, there has been proposed a type capable of accommodating a keyboard by erecting the keyboard against a main body including an upright display (for example, Japanese Unexamined Patent Publication No. Hei-3-164917, Japanese Unexamined Patent Publication No. 2000-284855, and Japanese Unexamined Patent Publication No. Hei-4-218820)

Among such personal computers, there is a type that a portion of a display screen of the display is exposed when the keyboard is accommodated. FIG. 14 shows a configuration diagram of a conventional personal computer, and FIG. 15 shows an explanation diagram of a screen display thereof. A display 1002 is provided to erect on a base portion 1000 having a power supply unit and main circuits. On the base portion 1000, a keyboard 1004 is disposed by means of a hinge 1100.

The keyboard 1004 is rotated around hinge 1100 from a horizontal state shown in the figure, and as shown by the dotted line, accommodated by being erected against the upright display 1002. At this time, as shown in FIGS. 14, 15, the lower screen portion of the display 1002 is covered with the keyboard 1004, while the upper portion thereof is exposed.

Conventionally, when the keyboard 1004 is accommodated without terminating the OS (Operating System) of the personal computer, as shown in FIG. 15, an application (clock, CD player, or the like) 1006 of the exposed screen size is initiated, so as to display on the exposed screen 1006 of display 1002. Thus, by operating the application, which does not use the keyboard, under an operation condition of the OS, the application has been provided for use by the user (for example, “Vaio WI” PCV-W120 (L), W120 (W), W110 (W), retrieved on Jun. 3, 2003 on the Internet URL:http://www.vaio.sony.co.jp/Products/Pdf/PCV-W120.p df).

According to the conventional method, in the form of use mounting such keyboard 1004, when performing display 1006 of the clock, etc. onto the exposed screen as shown in FIG. 15, it has been necessary to startup the application having been made to fit to the exposed screen size at that time.

Therefore, there has been a problem such that only applications for use dedicated to the screen size of interest can be used, and a variety of applications cannot be used, and as a result, a restricted number of applications can be displayed on the exposed screen 1006, and the user cannot use display on the exposed screen effectively.

Oppositely, in order to satisfy a variety of user needs, it has been necessary to develop the application for a variety of screen sizes, requiring a large amount of labor and time for the development, which has also been a problem.

### SUMMARY OF THE INVENTION

Accordingly, it is an object of the present invention to provide a screen display method of an information processing device, an information processing device, and a storage medium therefor, so as to enable the screen display without need of an application for dedicated use to the screen size thereof, when performing screen display onto an exposed screen of a display in a state of mounting a keyboard, etc.

Also, it is another object of the present invention to provide a screen display method of an information processing device, an information processing device, and a storage medium therefor, so as to display fit to the screen size thereof without using an application for dedicated use to the screen size thereof, when performing screen display onto an exposed screen of a display in a state of mounting a keyboard.

Further, it is still another object of the present invention to provide a screen display method of an information processing device, an information processing device, and a storage medium therefor, so as to display screens of a variety of applications when performing screen display onto an exposed screen of a display in a state of mounting a keyboard.

In order to achieve the aforementioned objects, the screen display method according to the present invention includes: a step of detecting that a first enclosure such as a keyboard has been positioned in the second enclosure including a display, so as to hide a portion of a screen of the display; and in response to the above detection, a step of modifying screen size information retained in an operating system.

Further, the information processing device according to the present invention includes: a first enclosure such as a keyboard; a second enclosure including a display and an information processor unit; a hinge for accommodating the first enclosure in the second enclosure so that the first enclosure hides a portion of the display screen; and a detector for detecting that the first enclosure has been positioned in the second enclosure so as to hide the portion of the display screen. Also, in response to the detection, the information processor unit modifies screen size information retained in an operating system.

Still further, the computer readable storage medium according to the present invention stores program for causing a data processor unit to perform processes of detecting that a first enclosure has been positioned in a second enclosure so as to hide a portion of the display screen, and in response to the detection, modifying screen size information retained in an operating system.

According to the present invention, when the first enclosure such as the keyboard is accommodated in the second enclosure including the display, the application image is displayed on the exposed screen by modifying the screen size information retained in the OS. Therefore, it becomes possible to perform screen display on the exposed screen without an application program for dedicated use. Moreover, since only the modification of the screen size is necessary, it becomes possible to switch over to the screen display on the exposed screen at high speed, and with simple processing.

Further, according to the present invention, preferably, the method further includes a step of displaying an application program image on a display area of the display corresponding to the screen size information.

Further, according to the present invention, preferably, the modification step includes a step for modifying the display screen resolution in the vertical direction only. With this, the display can be performed without omitting a display item(s) of the application program.

Further, according to the present invention, preferably, the display step includes a step of displaying images including at least a tool bar and a scroll bar. With this, necessary tools for screen operation can be displayed, and operation of the application is not impeded.

Further, according to the present invention, preferably, the detection step includes a step of detecting that the first enclosure has been accommodated in the display of the second enclosure. With this, a variety of application screens can be displayed on the exposed screen at the time of accommodation.

Further, according to the present invention, preferably, the detection step includes a step of detecting from an output of detection means for detecting that the first enclosure being attached to the second enclosure via a hinge has been accommodated in the second enclosure so as to hide the display in the second enclosure. With this, accommodation of the keyboard can be detected easily and surely.

Further, according to the present invention, preferably, the detection step includes a step of detecting from both an output of first detection means for detecting that the first enclosure has been attached to the hinge, and an output of second detection means for detecting that the hinge has been rotated and moved to the display in the second enclosure. With this, even when a configuration enabling separation of the first enclosure such as the keyboard from the display is adopted, it becomes easily possible to detect that the first enclosure such as the keyboard has been accommodated and the portion of the display has been hidden.

Further, according to the present invention, preferably, the detection step includes a step of detecting an angle of the first enclosure against the display in the second enclosure. With this, it becomes possible to control the screen to the maximum size viewable by the user, according to the accommodation state of the first enclosure such as the keyboard.

Further, according to the present invention, preferably, the modification step includes a step of modifying to the screen size information corresponding to the detected angle. With this, it becomes possible to easily control the screen to the maximum size viewable by the user, according to the accommodation state of the first enclosure such as the keyboard.

Further, according to the present invention, preferably, the above first enclosure is a keyboard. Accordingly, it is easily possible to apply to a general-purpose computer.

### BRIEF DESCRIPTION OF THE DRAWINGS

FIG. 1 shows an outer view of an information processing device of keyboard accommodation type, according to one embodiment of the present invention.

FIG. 2 shows an explanation diagram of the unit shown in FIG. 1, in a state of the keyboard being accommodated.

FIG. 3 shows an explanation diagram of the unit shown in FIG. 1, in a state of the keyboard being detached.

FIG. 4 shows a cross sectional view of the hinge unit shown in FIG. 1.

FIG. 5 shows an internal block diagram of the unit shown in FIG. 1.

FIG. 6 shows a configuration diagram of the operating system of the unit shown in FIG. 1.

FIG. 7 shows a process flowchart of the resident application shown in FIG. 6.

FIG. 8 shows an explanation diagram of the screen display operation shown in FIG. 7.

FIG. 9 shows an explanation diagram of a screen display example shown in FIG. 7.

FIG. 10 shows an explanation diagram of another screen display example shown in FIG. 7.

FIG. 11 shows a cross sectional view of an information processing device of keyboard accommodation type, according to another embodiment of the present invention.

FIG. 12 shows an explanation diagram of screen display operation shown in FIG. 11.

FIG. 13 shows a process flowchart of screen display interlocked with angle shown in FIG. 11.

FIG. 14 shows a configuration diagram of the conventional art.

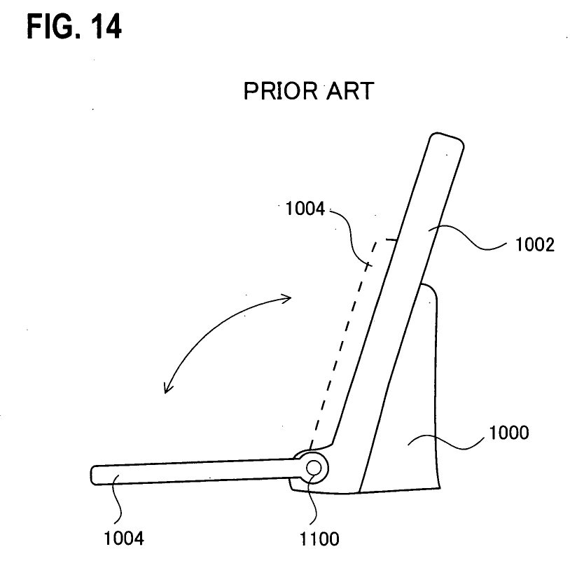

FIG. 15 shows an explanation diagram of the screen display operation according to the conventional art.

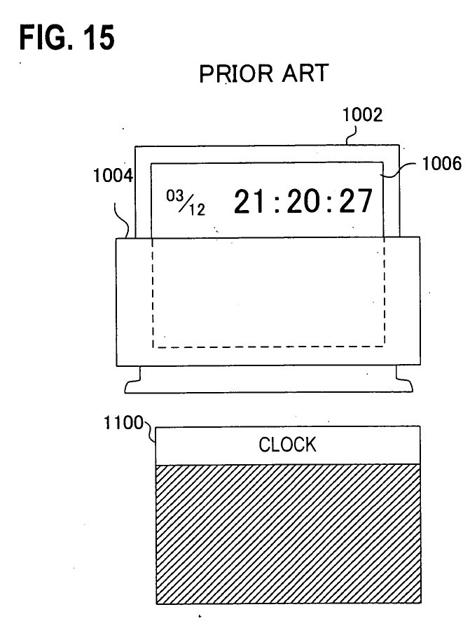

### DESCRIPTION OF THE PREFERRED EMBODIMENTS

The preferred embodiments of the present invention are described hereinafter, in the order of information processing device, screen display control processing, and other embodiments.

Information Processing Device

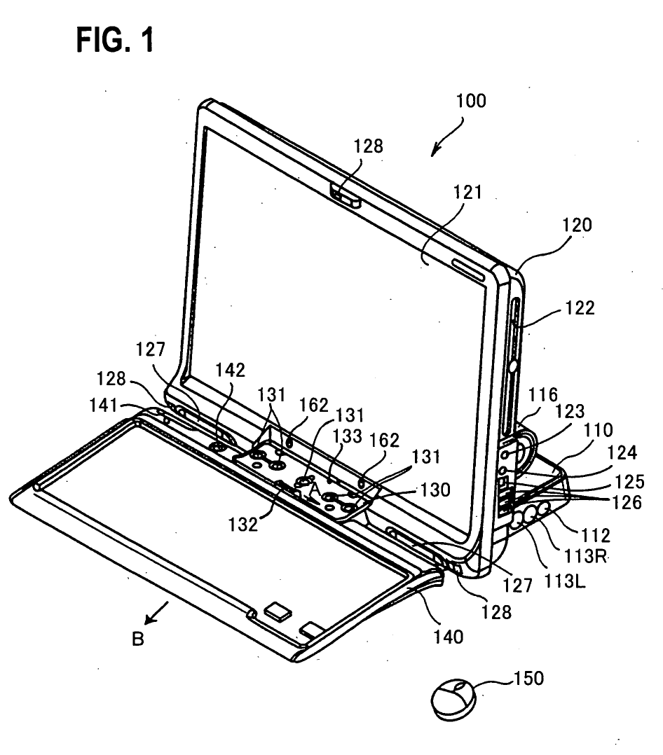

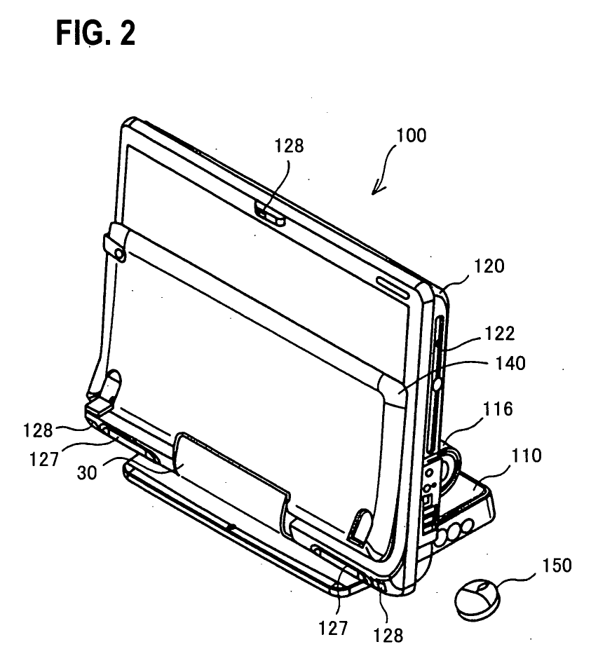

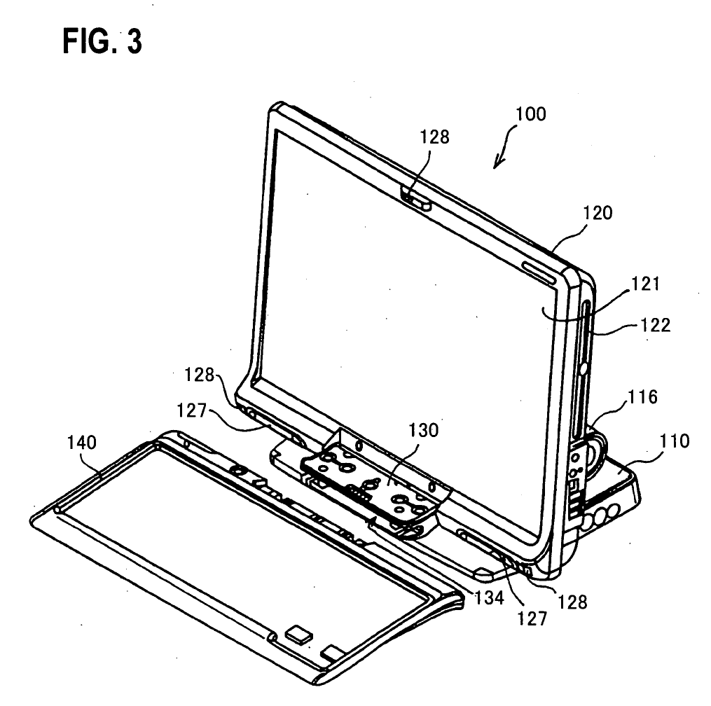

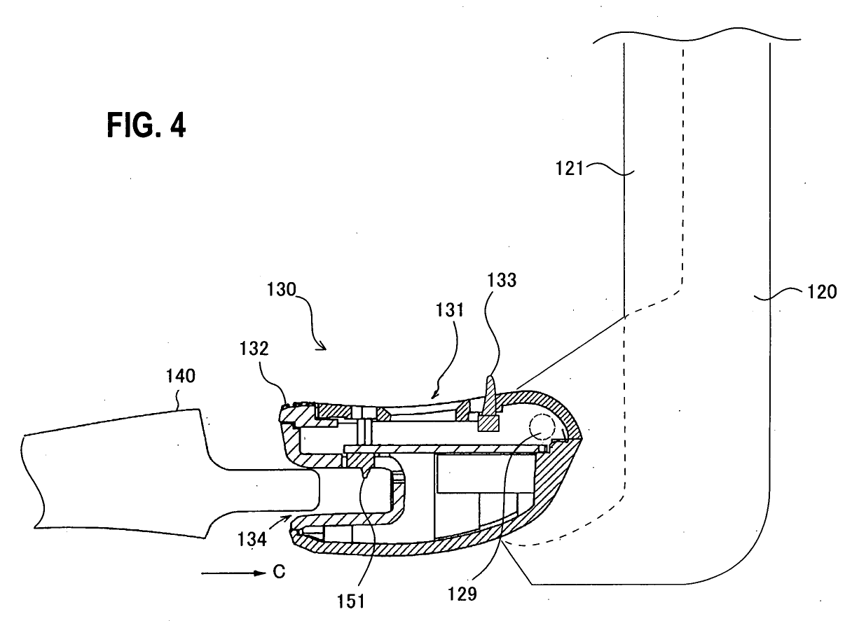

FIG. 1 shows an outer view of an information processing device of keyboard accommodation type, according to one embodiment of the present invention; FIG. 2 shows an explanation diagram of the unit shown in FIG. 1, at the time of the keyboard being accommodated; FIG. 3 shows an explanation diagram of the unit shown in FIG. 1, at the time of the keyboard being detached; and FIG. 4 shows a cross sectional view of the hinge shown in FIG. 1.

FIG. 1 exemplifies an integral personal computer 100 as an information processing device of keyboard accommodation type. As shown in FIG. 1, the personal computer 100 includes a base 110, an erection portion 120, a hinge unit 130, a keyboard 140 and a mouse 150.

The base 110 is a portion forming a foundation placed on a horizontal surface of a desk, etc. On the base 110, a non-illustrated battery pack is mounted, as well as a non-illustrated AC adaptor connection terminal. Further, on the base 110, there are provided an antenna terminal 112 for connecting to a television antenna, audio input terminals 113R and 113L, an S-video input terminal and a video input terminal (not shown). A woofer 116 is provided on the base 110.

Next, the erection portion 120 is supported in a state of erecting on the base 110, and provided with a liquid crystal display screen 121 on the front face thereof. This erection portion 120 is axially supported so as to rotating against the base 110 to a certain angle, and thereby regulating the elevation angle of the liquid crystal display screen 121.

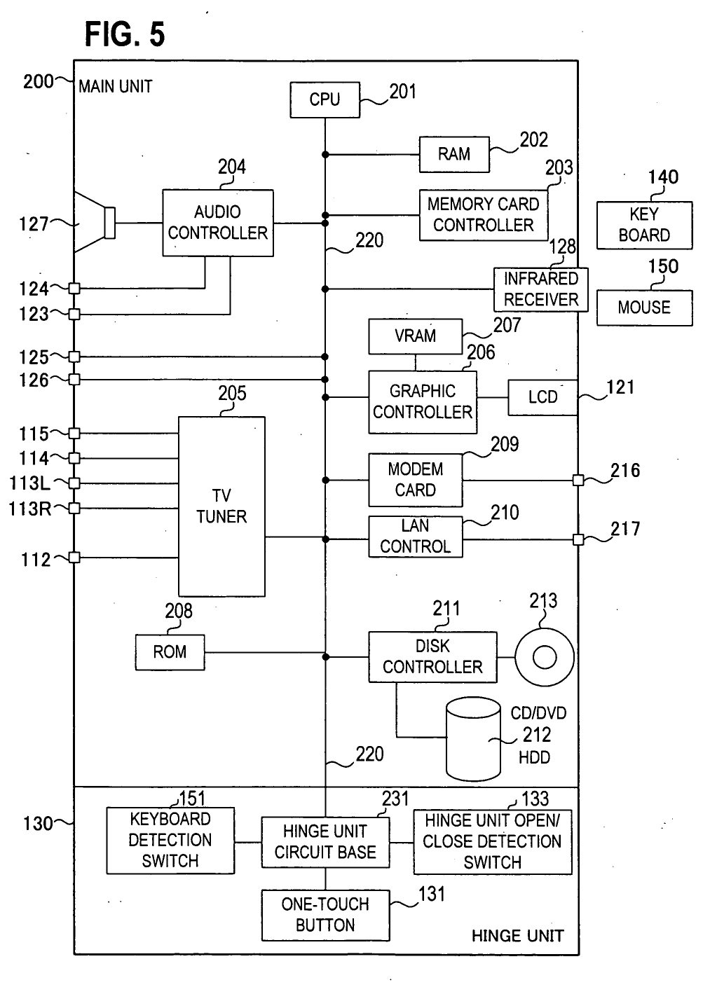

Also, on the above erection portion 120, on the back face side of the display screen 121, there is mounted a main arithmetic operation function portion of a computer, including a CPU and a hard disk, as will be described in FIG. 5. Further, on the side face of the erection portion 120, there are provided a CD/DVD loading inlet (slot) 122 for loading a CD (Compact Disk) and a DVD (Digital Versatile Disk), a headphone output terminal 123 for inserting a headphone jack, a microphone input terminal 124 for inserting a microphone jack, a connector terminal 125 for inserting a communication cable connector conforming to the communication standard of IEEE 1394, three connector terminals 126 for inserting communication cable connectors conforming to the communication standard of USB.

Further, on the lower portion of the front face of the erection portion 120, two speakers 127 at right and left, and a total of three infrared receivers 128, one each on the right or left lower portion and one on the upper portion, are provided. The above infrared receivers 128 are provided for receiving infrared for communication transmitted from the keyboard 140 and the mouse 150 described later.

Also, on the hinge unit 130, five one-touch buttons 131 are provided. The hinge unit 130 includes a built-in circuit board having a circuit for detecting the operation of one-touch buttons 131, and transmitting the detection result to the erection portion 120.

To each of the above five one-touch buttons 131, it is possible to assign each function correspondingly, for example, startup of a program for the Internet when a certain one-touch button is depressed.

Also, the above hinge unit 130 is provided for detachably supporting the keyboard 140. On the hinge unit 130, a removal operation button 132 is provided for detaching from the hinge unit 130 the keyboard 140 mounted on the hinge unit 130.

FIG. 3 shows a perspective view which illustrates a state of the keyboard 140 being detached from the hinge unit 130. As shown in FIG. 3, the hinge unit 130 includes a slit-shaped keyboard grip 134 extending right and left, for gripping the keyboard 140.

By inserting the keyboard 140 into the grip 134 of the hinge unit 130, while being left in a position shown in FIG. 3, the keyboard 140 is mounted on the hinge unit 130, as shown in FIG. 1. Also, by operating the removal operation button 132 to the direction shown by an arrow A illustrated in FIG. 1, the engagement between the keyboard 140 and the hinge unit 130 is detached. Then, by drawing the keyboard 140 to the direction shown by an arrow B illustrated in FIG. 1, the keyboard 140 is detached from the hinge unit 130, as shown in FIG. 3.

The above hinge unit 130 is axially supported by a support axis 129 (refer to FIG. 4) disposed on the erection portion 120, and rotates around the above support axis 129. With this, the keyboard 140 can be rotated between a close state in which the keyboard 140 covers the liquid display screen 121, as shown in FIG. 2, and an open state in which the keyboard 140 is opened from the erection portion 120 so as to expose the entire face of the liquid crystal display screen 121, as shown in FIG. 1.

Further, as shown in FIG. 4, the hinge unit 130 is provided with a hinge unit open/close detection switch 133 for detecting whether the hinge unit 130 lies in the open state shown in FIG. 1 or the close state shown in FIG. 2, and a keyboard detection switch 151 for detecting whether the keyboard 140 is mounted on the hinge unit 130 or the keyboard 140 is detached from the hinge unit 130 as shown in FIG. 3.

By means of the circuit on a circuit board incorporated in the hinge unit 130, in addition to the detection of depression of five one-touch keys 131, the detection of ON/OFF of both the hinge unit open/close detection switch 133 and the keyboard detection switch 151 is performed also.

In addition, as shown in FIG. 1, a receiver 162 formed of an elastic body such as rubber is disposed on the erection portion 120. The above receiver 162 flexibly receives the abutment of the hinge unit 130 when being folded as shown in FIG. 2.

Also, on the keyboard 140, a multiplicity of keys (not shown in the figure) for accepting key operation are arrayed, and further, there are provided an infrared transmitter 141 for transmitting key operation information, and a ‘Suspend’ button 142 for starting up the integral personal computer 100 from a suspended state. The key operation information transmitted from the infrared transmitter 141 of the keyboard 140 is received in the infrared receiver 128 disposed on the erection portion 120.

On the mouse 150 also, infrared transmitter (not shown) for transmitting operation information of the mouse 150 is provided, and the mouse operation information transmitted from the above infrared transmitter is received in infrared receiver 128 disposed on the erection portion 120.

Here, as to the size of the keyboard 140, in regard to the size in the right and left direction is approximately the same as the erection portion 120, while the size in regard to the depth direction shown in FIG. 1 (that is, the upward and downward direction in the close state shown in FIG. 2) is smaller than the erection portion 120; Therefore, in the close state shown in FIG. 2, the keyboard 140 covers only a portion of the display screen 121 of the erection portion 120. Even in the close state shown in FIG. 2, an approximately one-third of the upper side area of the display screen 121 is left exposed.

Using such the upright personal computer 100, it is possible to utilize the space on the desk widely during the state of the keyboard being accommodated, as shown in FIG. 2. Also, when using the keyboard 140, by opening the keyboard 140, in addition to the use in the state shown in FIG. 1, it is also possible to operate by detaching the keyboard 140, as shown in FIG. 2. In the use pattern shown in FIG. 3, it is possible to separate the keyboard 140 from the main units 120, 110 including the display. The keyboard 140 can be placed and operated without being restricted by the location of the main units.

Also, as shown by the close state shown in FIG. 2, because the keyboard 140 covers only a portion of the display screen 121 on the erection portion 120, and the approximately one-third of the upper side area of the display screen 121 is left exposed, a variety of screens can be displayed on the above exposed screen.

Screen Display Control Processing

Next, screen display control processing of the aforementioned personal computer will be described. FIG. 5 shows a circuit block diagram of the integral personal computer 100 according to the embodiment shown in FIG. 1 through 3.

Main unit 200 shown in FIG. 5 is a portion in which base 110 and erection portion 120 shown in FIG. 1 are combined. In the above main unit 200, there are provided CPU 201, RAM (Random Access Memory) 202, a memory card controller 203, an audio controller 204, a television tuner 205, a graphic controller 206, VRAM (video RAM) 207, the liquid crystal display 121, ROM (Read Only Memory) 208, a modem card 209, a LAN controller 210, and a disk controller 211.

Further, the main unit 200 is provided with the infrared receiver 128 as shown in FIG. 1 also, the connector terminal 125 conforming to the IEEE 1394 standard, and the connector terminals 126 conforming to the USB standard, which are mutually connected via a bus 220.

CPU 201 is an element for performing a variety of types of arithmetic operation processing by executing programs. RAM 202 is a memory for expanding programs for the execution in CPU 201, and for working use during the program execution by CPU 201.

The memory card controller 203 is a controller for accessing a non-illustrated memory card. The audio controller 204 is connected to the headphone output terminal 123, the microphone input terminal 124 and the speaker 127, so as to convert an audio signal being input from the microphone input terminal 124 into a digital signal and to take internally, and to convert a digital signal transmitted via bus 220 into an analog signal, to transmit to the speaker 127 and the headphone output terminal 123.

Also, as described earlier, the infrared receiver 128 is provided for receiving operation information of the keyboard 140 and the mouse 150. The television tuner 205 is connected to the antenna input terminal 112, the audio input terminals 113R, 113L, the S-video input terminal 114 and the video input terminal 115, which is an element for playing the role of recording and playback of television broadcast and video.

Further, the non-illustrated memory card is a portable memory card which can arbitrarily inserted in the personal computer of integrated structure, such as, for example, Memory Stick and SD memory card. The memory card is accessed by the memory card controller 203.

The liquid crystal display (LCD) 121 provides a liquid crystal display screen shown in FIG. 1, for displaying a variety of images on the liquid crystal display screen 121 thereof, according to an instruction of CPU 201. ROM 208 is a memory element for storing fixed data and programs. The modem card 209 is an element for performing a kind of communication, and is connected to the communication connector 216. Also, the LAN controller 210 is an element for performing a kind of communication, and is connected to the communication connector 217.

Further, the disk controller 211 accesses a hard disk 212 incorporated in the main unit 200, and a CD/DVD 213 loaded from the CD/DVD loading inlet 122 shown in FIG. 1.

VRAM 207 is a screen memory of the liquid crystal display 121, and stores image data for at least one page of the screen, desirably a few pages, in the form of bitmap. The graphic controller 206 expands an image to bitmap image onto a screen area of VRAM 207 specified by CPU 201, reads out the bit image from a screen start address of VRAM 207, and controls display of the liquid crystal display 121.

Also, the hinge unit 130 shown in the lower portion of FIG. 5 is provided with a hinge unit circuit board 231 connected to the bus 220, in addition to the aforementioned one-touch buttons 131, the hinge unit open/close detection switch 133 and the keyboard detection switch 151. The above hinge unit circuit board 231 plays the role of detecting the operation of the one-touch buttons 131, and ON/OFF of the hinge unit open/close switch 133 and the keyboard detection switch 151, and transmitting it to CPU 201.

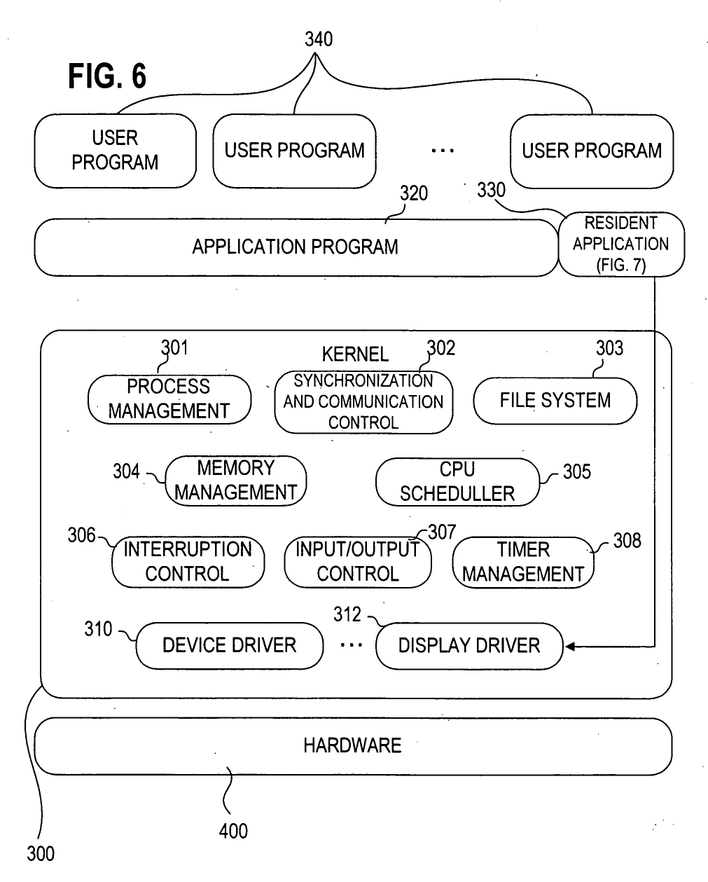

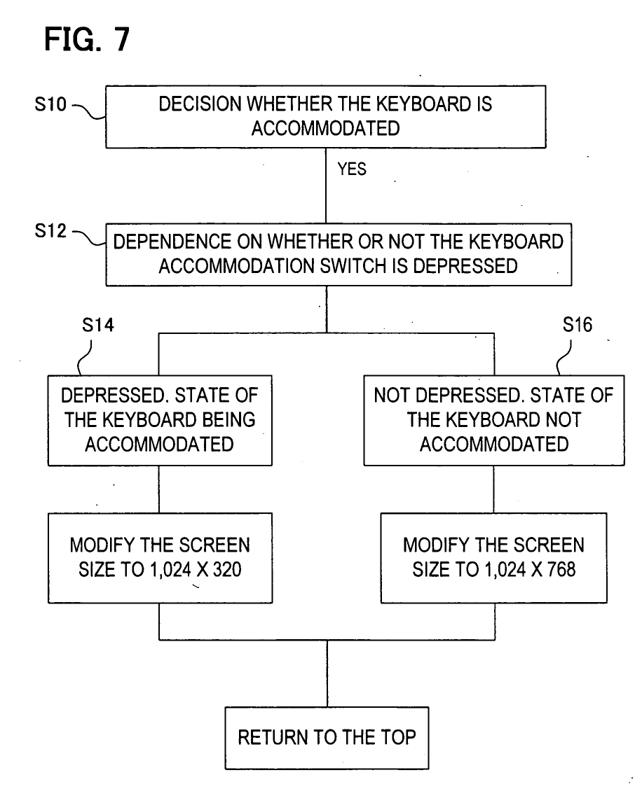

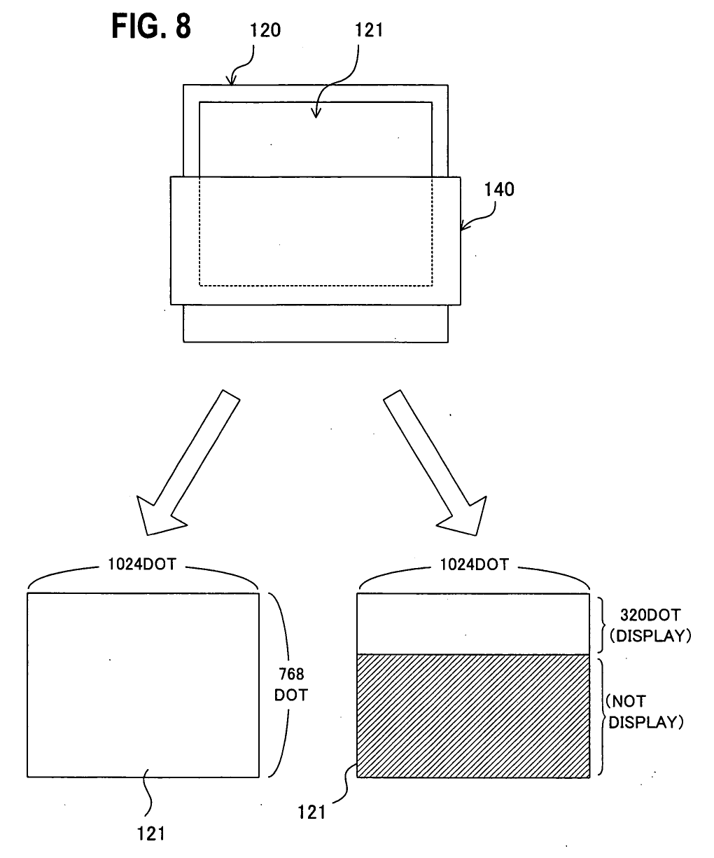

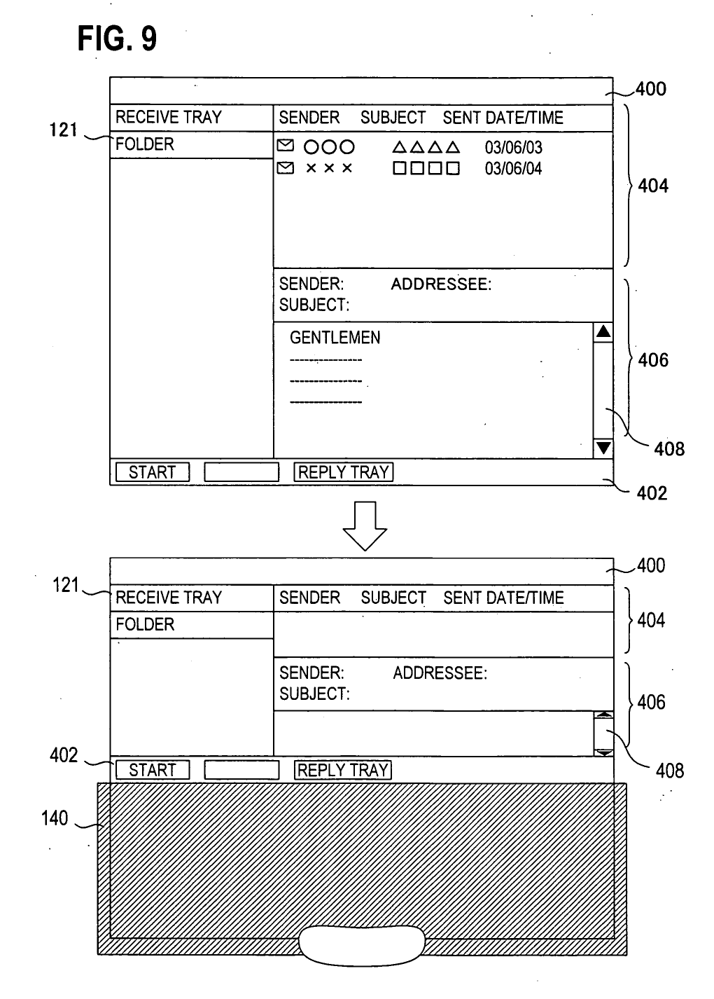

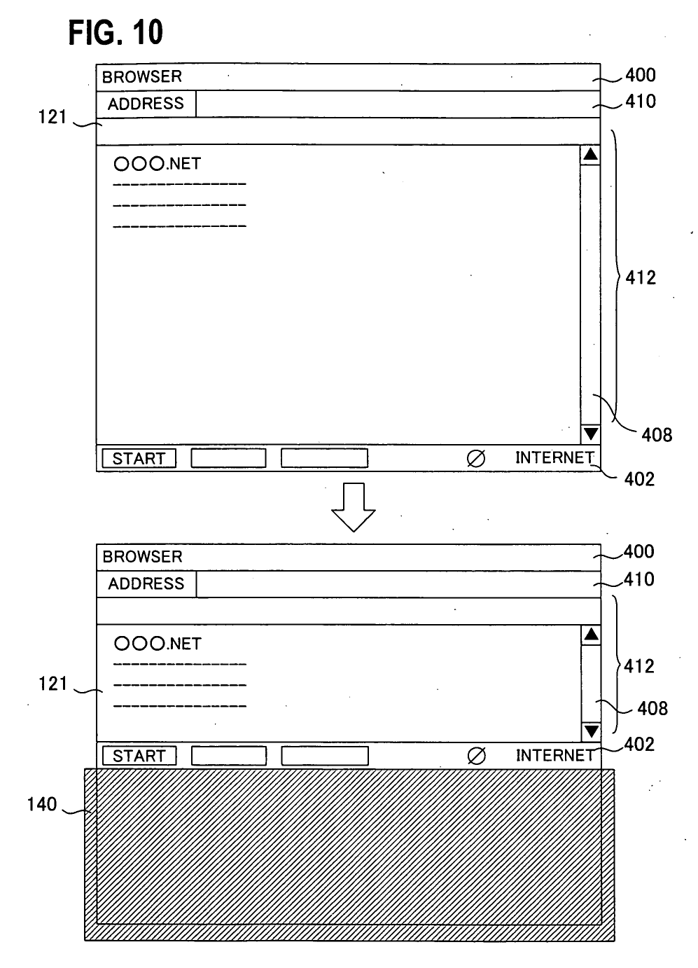

FIG. 6 shows a program configuration diagram executed by CPU 201, FIG. 7 shows a processing flowchart of a resident application program shown in FIG. 6, FIG. 8 shows an explanation diagram of the operation shown in FIG. 7, and FIGS. 9 and 10 show explanation diagrams of exemplary screen display by FIG. 7.

As shown in FIG. 6, the OS (operating system) of CPU 201 is provided with a kernel 300 for controlling hardware 400, application program 320 and necessary user programs 340.

The kernel 300 is a core portion of the OS, and includes a process control program 301 for managing processing processes, a synchronization and communication control program 302 for performing synchronization and communication control, a file system 303 for performing file management, a memory management program 304 for performing memory management, a CPU scheduler 305 for performing schedule management of the CPU, an interruption control program 306 for performing interruption control, an input/output control program 307 for performing input/output control, a timer management program 308 for performing timer management, device drivers 310 for driving devices, and a display driver 312 for driving the display.

Further, according to the present invention, there is provided a resident application 330, which will be illustrated in FIG. 7, for performing screen control in cooperation with the switch provided in hinge 130, via display driver 312.

FIG. 7 shows a processing flowchart of the screen control application program operated in cooperation with the above switch.

(S10) CPU 201 decides whether the keyboard 140 is accommodated in the hinge unit 130. Namely, in order to decide whether the keyboard 140 lies in the keyboard accommodation state shown in FIGS. 1 and 2, CPU 201 decides whether the keyboard detection switch 151, shown in FIGS. 4 and 5, has detected the keyboard 140 (ON state).

(S12) Next, on deciding that the keyboard 140 is accommodated in the hinge unit 130, CPU 201 decides whether the keyboard 140 is accommodated in the display 121. Namely, in order to decide whether the keyboard 140 lies in the keyboard accommodation state, CPU 201 decides whether the hinge unit open/close detection switch (keyboard accommodation switch) 133 has detected the close state of the hinge unit 130 (ON state).

(S14) On detecting that both switches 151, 133 are in ON state, CPU 201 decides that the keyboard 140 lies in the keyboard accommodation state shown in FIG. 2, and shifts to a half display mode. For example, in the case that one-third of the display screen of the above display 121 is exposed, CPU 201 issues an instruction of modifying the screen size to 1,024×320 to the display driver 312. Namely, the screen size information retained in the OS is modified. With this, the graphic controller 206 instructed from the display driver 312, writes an application image for 320 dots in the vertical direction of one screen area of VRAM 207. Accordingly, as shown in FIG. 8, on the screen of the display 121, the image is displayed on the upper 320 dots in the vertical direction, and the remaining lower portion becomes black screen.

(S16) CPU 201 decides that switch 151 is ON, while switch 133 is not in the ON state, CPU 201 decides that keyboard 140 lies in a keyboard open state shown in FIG. 1, and shifts to a full display mode. For example, CPU 201 issues an instruction of modifying the screen size of the display screen of the display 121 to a full screen size of 1,024×768 to the display drive 312. Namely, the screen size information retained in the OS is modified. With this, the graphic controller 206 instructed from display driver 312, writes an application image in the whole of one screen area of VRAM 207. Accordingly, as shown in FIG. 8, the application image is displayed throughout the whole screen of display 121.

FIG. 9 shows an example of the above screen control, illustrating a reception tray screen of Outlook Express of the Windows (trademark, Microsoft Corp.) OS. The upper stage shows a maximized screen, while the lower stage shows a half-sized screen. The screen concerned provides tool bars 400, 402 in the upper and lower portions, and also a list 404, a selected mail 406 and a scroll bar 408 therebetween.

When a full size is instructed, as shown in the upper stage of FIG. 9, a reception tray screen is displayed over the whole screen 121. Meanwhile, when a half size is instructed, there are displayed, inside the exposed screen of screen 121, the reception tray screen with the tool bars 400, 402 above and below, and the list 404, the selected mail 406 and the scroll bar 408 therebetween. In the above half-sized screen also, by operating the scroll bar 408 with the mouse, the mail content can be scrolled.

FIG. 10 shows another example of the screen control, illustrating a browser screen of Internet Explorer on the Windows (trade mark, Microsoft Corp.) OS. The upper stage shows a maximized screen, while the lower stage shows a half-sized screen. The screen concerned provides the tool bars 400, 402 above and below, and a browser area 412 having an address 410 and a scroll bar 408 therebetween.

When a full size is instructed, as shown in the upper stage of FIG. 10, the browser screen is displayed over the whole screen 121. Meanwhile, when a half size is instructed, inside the exposed screen of screen 121, there is displayed the browser area 412 with the tool bars 400, 402 above and below, and also the address 410 and the scroll bar 408 therebetween. In the above half-sized screen also, by operating the scroll bar 408 with the mouse, the browser content can be scrolled.

As such, when the keyboard is accommodated in the display, since the application image is displayed on the exposed screen by modifying the screen size information retained in the OS, it becomes possible to perform screen display on the exposed screen without an application program for dedicated use. Moreover, since only the modification of the screen size is necessary, it becomes possible to switch over to the screen display on the exposed screen at high speed, and with simple processing.

### Other Embodiments

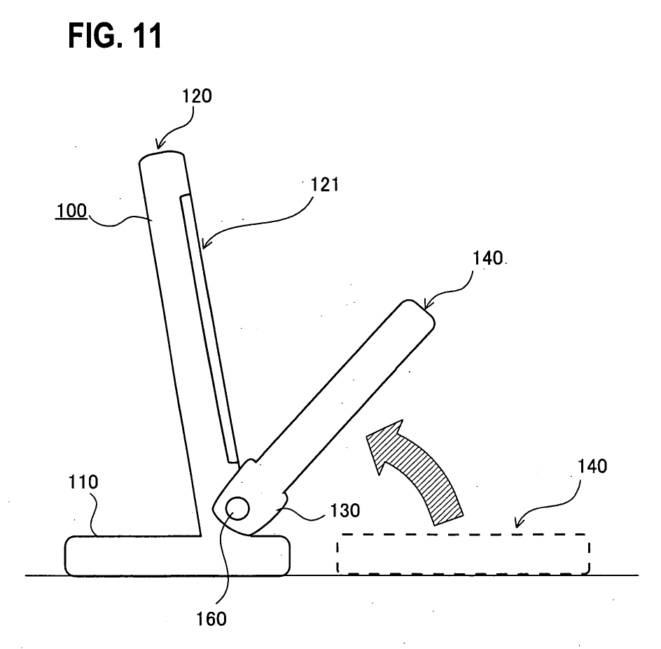

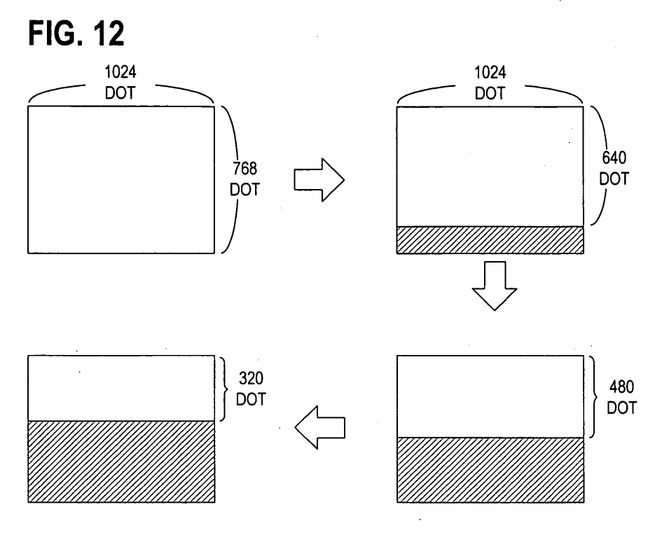

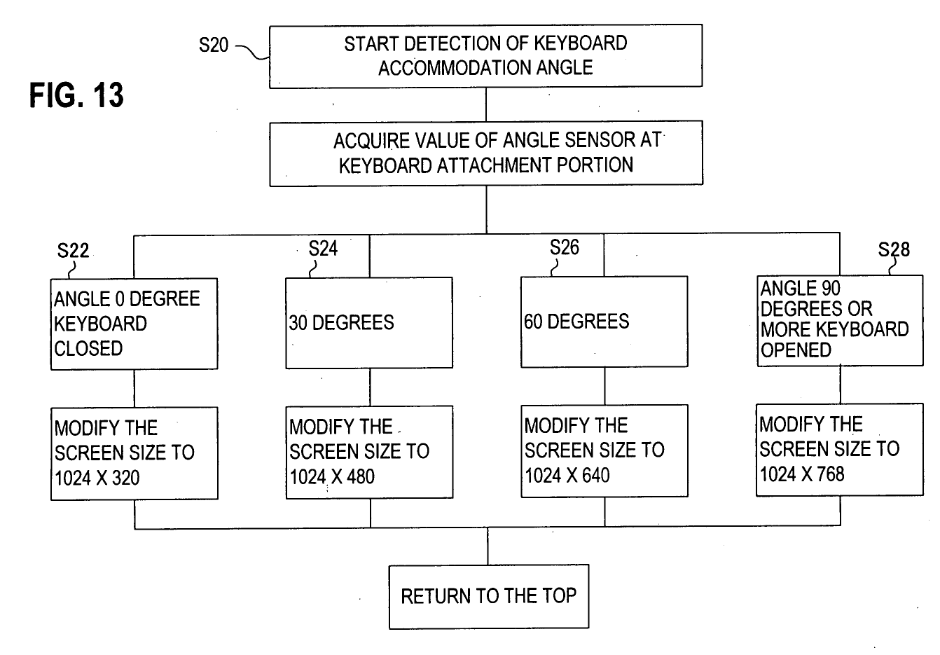

FIG. 11 shows a cross-sectional view of the information processing device of keyboard accommodation type, according to another embodiment of the present invention. FIG. 12 shows an explanation diagram of the screen display operation thereof. FIG. 13 shows a flowchart of screen display processing shown in FIG. 11.

In FIG. 11, the same portions shown in FIGS. 1 through 4 are referred to by the same symbols. In the present embodiment, there is provided an angle sensor 160 for detecting a rotation angle of the hinge unit 130.

The screen display control processing processed by CPU 201 shown in the block diagram of FIG. 5 will be explained, referring to FIG. 13.

(S20) CPU 201 decides whether the keyboard 140 is accommodated in the hinge unit 130. Namely, in order to decide whether the keyboard 140 lies in the keyboard accommodation state shown in FIG. 1, CPU 201 decides whether the keyboard detection switch 151 shown in FIGS. 4 and 5 has detected the keyboard 140 (ON state). Next, on-deciding that the keyboard 140 is accommodated in the hinge unit 130, CPU 201 reads the value of the angle sensor 160.

(S22) On deciding that the value of angle sensor 160 is 0 degree, CPU 201 decides that the keyboard 140 lies in the keyboard accommodation state shown in FIG. 2, and issues an instruction to the display drive 312 to modify the above-mentioned screen size of the display 121 to 1,024×320, as an example. Namely, the screen size information retained in the OS is modified. With this, the graphic controller 206 instructed from display driver 312, writes an application image for 320 dots in the vertical direction of one screen area of VRAM 207. Accordingly, as shown in FIGS. 8 through 10 and FIG. 12, on the screen of display 121, the image is displayed on the upper 320 dots in the vertical direction, and the remaining lower portion becomes black screen.

(S24) On deciding that the value of angle sensor 160 is 30 degrees, CPU 201 decides that the keyboard 140 lies in an oblique keyboard accommodation state shown in FIG. 11, and issues an instruction to the display drive 312 to modify the above-mentioned screen size of the display 121 to 1,024×480, as an example. Namely, the screen size information retained in the OS is modified. With this, the graphic controller 206 instructed from the display driver 312, writes an application image for 480 dots in the vertical direction of one screen area of VRAM 207. Accordingly, as shown in FIG. 12, on the screen of the display 121, the image is displayed on the upper 480 dots in the vertical direction, and the remaining lower portion becomes black screen.

(S26) On deciding that the value of the angle sensor 160 is 60 degrees, CPU 201 decides that keyboard 140 lies in a further oblique keyboard accommodation state shown in FIG. 11, and issues an instruction to the display drive 312 to modify the above-mentioned screen size of the display 121 to 1,024×640, as an example. Namely, the screen size information retained in the OS is modified. With this, the graphic controller 206 instructed from the display driver 312, writes an application image for 640 dots in the vertical direction of one screen area of VRAM 207. Accordingly, as shown in FIG. 12, on the screen of the display 121, the image is displayed on the upper 640 dots in the vertical direction, and the remaining lower portion becomes black screen.

(S28) On deciding that the value of the angle sensor 160 is 90 degrees or more, CPU 201 decides that the keyboard 140 lies in the keyboard open state shown in FIG. 1, and issues an instruction to the display drive 312 to modify the above-mentioned screen size of the display 121 to the full 1,024×768. Namely, the screen size information retained in the OS is modified. With this, the graphic controller 206 instructed from the display driver 312, writes an application image into the whole of one screen area of VRAM 207. Accordingly, as shown in FIG. 12, the screen of the display 121 is utilized for the application to the maximum.

As such, with the provision of the angle sensor, it becomes possible to modify to the screen of a maximum size viewable by the user. Needless to say, it is possible to realize without provision of an application for dedicated use, because the screen size retained in the OS is modified also in this case.

In the above, the present invention has been described according to the embodiments. However, a variety of modifications may be possible within the scope of the present invention. The foregoing description of the embodiments is not intended to exclude such the modification from the technical scope of the present invention.

For example, as personal computer, the description has been made using a desktop personal computer for use on the desk or a notebook personal computer. However, the present invention is also applicable to other portable electronic apparatuses such as PDA. Further, although the description has been made using an apparatus capable of detaching a keyboard from a display, the present invention is also applicable to an apparatus which is not detachable. Further, in addition to an electronic mail and a browser, the present invention is also applicable to other applications. Although the first enclosure has been explained as keyboard, the present invention is also applicable to other input devices such as a coordinate input device.

According to the present invention, when a first enclosure such as a keyboard is accommodated in a display, since an application image is displayed on an exposed screen by modifying the screen size information retained in the OS, it becomes possible to perform screen display on the exposed screen without an application program for dedicated use. Moreover, since only the modification of the screen size is necessary, it becomes possible to switch over the screen display onto the exposed screen at high speed, and with simple processing.

What is claimed is:

1. A screen display method of an information processing device constituted of a first enclosure and a second enclosure having a display device, comprising:
a step of detecting that the first enclosure has been positioned in the second enclosure so as to hide a portion of the screen of the display device; and
a step of modifying screen size information retained in an operating system of the information processing device in response to the detection,

2. The screen display method of the information processing device according to claim 1, further comprising:
a step of displaying an application program image on a display area of the display device corresponding to the screen size information.

3. The screen display method of the information processing device according to claim 1,
wherein the modification step comprises a step of modifying a display screen resolution in a vertical direction of the display device only.

4. The screen display method of the information processing device according to claim 1,
wherein the detection step includes a step of detecting that the first enclosure has been accommodated in the display device of the second enclosure.

5. The screen display method of the information processing device according to claim 4,
wherein the detection step comprises a step of detecting from an output of detection means for detecting that the first enclosure being attached to the second enclosure via a hinge has been accommodated in the second enclosure so as to hide the display screen in the second enclosure.

6. The screen display method of the information processing device according to claim 1,
wherein the detection step comprises a step of detecting an angle of the first enclosure against the display screen in the second enclosure.

7. The screen display method of the information processing device according to claim 1,
wherein the detection step comprises a step of detecting that a keyboard constituting the first enclosure has been positioned in the second enclosure so as to hide a portion of the display screen.

8. An information processing device comprising:
a first enclosure;
a second enclosure including a display device and an information processor unit;
a hinge for accommodating the first enclosure in the second enclosure so that the first enclosure hides a portion of a display screen of the display device; and
a detector for detecting that the first enclosure has been rotated and moved to the second enclosure so as to hide a portion of the display screen,
wherein the information processor unit modifies screen size information retained in an operating system of the information processor unit in response to the detection.

9. The information processing device according to claim 8,
wherein the information processor unit displays an application program image on a display area of the display device corresponding to the screen size information.

10. The information processing device according to claim 8,
wherein the information processor unit modifies a display screen resolution in the vertical direction of the display device only.

11. The information processing device according to claim 8,
wherein the detector comprises a detector for detecting that the first enclosure is in a position of being accommodated in the display device of the second enclosure.

12. The information processing device according to claim 11,
wherein the detector comprises a detector for detecting that the first enclosure being attached via a hinge has been accommodated in the second enclosure so as to hide the display device in the second enclosure.

13. The information processing device according to claim 8,
wherein the detector comprises an angle sensor for detecting an angle of the first enclosure against the display device in the second enclosure.

14. The information processing device according to claim 8,
wherein the first enclosure comprises a keyboard.

15. A computer readable storage medium stored program for displaying on a screen of an information processing device comprising a first enclosure and a second enclosure having a display device and an information processor unit, said program cause the information processor unit to execute:
a step of detecting that the first enclosure has been positioned in the second enclosure so as to hide a portion of a display screen; and
a step of modifying screen size information retained in an operating system of the information processor unit in response to the detection.

16. The computer readable storage medium according to claim 15, wherein the program further causing the information processor unit to execute:
a step of displaying an application program image on a display area of the display device corresponding to the screen size information.

17. The computer readable storage medium according to claim 15,
wherein the modification step comprises a step of modifying a display screen resolution in the vertical direction of the display device only.

18. The computer readable storage medium according to claim 15,
wherein the detection step comprises a step of detecting that the first enclosure has been accommodated in the display device of the second enclosure.

19. The computer readable storage medium according to claim 18,
wherein the detection step comprises a step of detecting from an output of a detection means for detecting that the first enclosure being attached via a hinge has been accommodated in the second enclosure so as to hide the display screen in the second enclosure.

20. The computer readable storage medium according to claim 15,
wherein the detection step comprises a step of detecting an angle of the first enclosure against the display device in the second enclosure.

21. The computer readable storage medium according to claim 15,
wherein the detection step comprises a step of detecting that a keyboard constituting the first enclosure has been positioned in the second enclosure so as to hide the portion of the display screen.
